(19) United States
(12) Patent Application Publication
(10) Pub. No.: US 2018/0169947 A1
(43) Pub. Date: Jun. 21, 2018

(54) ADDITIVE MANUFACTURING APPARATUS WITH RECOAT UNIT AND PROCESS USING THE SAME

(71) Applicant: AddiFab ApS, Jyllinge (DK)

(72) Inventor: Jon JESSEN, Veksø (DK)

(21) Appl. No.: 15/574,958

(22) PCT Filed: May 19, 2016
(86) PCT No.: PCT/EP2016/061354

§ 371 Date: Nov. 17, 2017

(30) Foreign Application Priority Data
May 19, 2015 (DK) PA201570295

(51) Int. Cl. B29C 64/336; B29C 64/255; B29C 64/129; B29C 64/291; B29C 64/205; B29C 64/35; B29C 64/314; B33Y 30/00; B29C 64/188; B29C 64/386; B29C 64/295; B33Y 10/00; B33Y 50/00; B33Y 40/00

(52) U.S. Cl. CPC B29C 64/336; B29C 64/255; B29C 64/129; B29C 64/291; B29C 64/205; B29C 64/35; B33Y 40/00; B33Y 30/00; B29C 64/188; B29C 64/386; B29C 64/295; B33Y 10/00; B33Y 50/00; B29C 64/314

(57) ABSTRACT

The present invention provides an additive manufacturing apparatus comprising: a build vat for holding a radiation-curable liquid, a build platform having a build surface for holding a product to be manufactured during a manufacturing process, the build platform being movable relative to the build vat in a predetermined direction, and a radiation source for providing hardening radiation to selectively solidify radiation-curable liquid in the build vat by exposure to form the product. The apparatus is characterized in that the additive manufacturing apparatus further comprises a recoat unit, the recoat unit being configured to perform a recoat procedure, the recoat procedure comprising: the recoat unit sweeping across at least a part of a surface of the radiation-curable liquid in the build vat, the recoat unit supplying additional radiation-curable liquid at the surface of the radiation-curable liquid during at least a part of said sweeping, the radiation-curable liquid being added by a feeder unit. A corresponding method is also provided.

### TECHNICAL FIELD

The present invention relates to additive manufacturing.

### BACKGROUND OF THE INVENTION

Additive manufacturing has gained solid acceptance as a tool for prototyping and production of unique/custom-fit products (hearing aids, jewelry, dental implants, etc.). For these and other applications, a well-known principle is to sequentially expose a photo-sensitive liquid to a suitable number of solidifying radiations with the purpose of building one or more products. This method is frequently referred to as stereolithography.

A well-known stereolithographic principle of operation is to position a light-source above a build vat that contains a photo-sensitive liquid. Said light-source projects an image with a desired geometry onto a build platform (that is placed immediately below the surface of said photo-sensitive liquid) to solidify the photo-sensitive liquid that lies between the light-source and the platform in a shape corresponding with the geometry of the projected image. Building of additional layers of the product to be manufactured may be done by lowering the build platform a distance corresponding with a desired layer thickness and projecting a second image with a desired geometry onto the newly formed layer.

To ensure that the surface of the photo-sensitive liquid is even, and thereby that building of a second layer can be initiated as soon as possible after the building of the first layer, recoating has emerged as a useful principle associated with stereolithography (and other methods of additive manufacturing, such as Selective Laser Sintering (SLS) and Selective Laser Melting (SLM)).

An exemplary embodiment of a recoat system is disclosed in patent specification EP045762A1, and comprises a doctor blade that is configured to move over a build platform that is disposed in a build vat containing a photo-sensitive liquid with the purpose of forming a substantially uniform surface. A dispenser unit is configured to dip into the build vat to collect an amount of photo-sensitive liquid and to distribute at least part of said amount over the free surface of the build vat before advancing the doctor blade to ensure that a sufficient amount of material is available for spreading over the surface of the build vat by the doctor blade. Patent specification JP0524120 discloses a similar principle where the dipping of a dispenser unit into the build vat is replaced with the scooping of photo-sensitive liquid from the build vat into a feeder unit that may then distribute the photo-sensitive liquid across the free surface of the build vat. Yet a similar principle is disclosed by patent specification U.S. Pat. No. 5,432,045, which drags a recoat unit across a free surface of a build vat to distribute unsolidified photo-sensitive liquid by means of a clearance between the recoat unit and the free surface that is small enough to cause suction of the unsolidified photo-sensitive liquid into the clearance due to surface tension.

Patent specification U.S. Pat. No. 5,902,537 discloses an alternative principle where a recoat unit comprising a counter-rotating roller is employed to distribute photo-sensitive liquid across a free surface of the build vat. Additionally or alternatively, a material dispenser and/or a material transporter are used to further improve distribution of material. In some embodiments of U.S. Pat. No. 5,902,537, material is drawn from the bottom of the build vat and pumped into the material dispenser.

Patent specification U.S. Pat. No. 5,922,364 discloses yet an alternative principle where a recoat unit is connected to a reservoir of photo-sensitive liquid that is external to the build vat and where photo-sensitive liquid may be transferred from said reservoir to said recoat unit by means of elevation of the reservoir to exploit a gravity feed mechanism or alternatively by means of a pump or a similar impelling means that produces a small positive pressure. Said positive pressure aids in ensuring a proper distribution of photo-sensitive liquid across the free surface of the build vat.

In summary, the disclosures referenced above provide methods for ensuring that a single material is homogeneously distributed across a free surface in preparation of solidification of a layer in an additive manufacturing process. However, there is an increasing interest in the application of additive manufacturing as a technology for higher-volume production of components that may be made of more than one material. For these applications, systems that are able to operate continuously, with a high degree of automation, and with the option of changing between multiple materials are desirable since they support increased flexibility and reductions in the time it takes to manufacture a product by additive manufacturing.

### SUMMARY OF THE INVENTION

The present invention provides additively manufacturing products using multiple materials. It mitigates several of the factors that add to the manufacturing time in additive manufacturing apparatuses. It also mitigates other factors that may constrain the usefulness of additive manufacturing apparatuses, especially for higher volume production.

In a first aspect, the invention provides an additive manufacturing apparatus comprising:
a build vat for holding a radiation-curable liquid,
a build platform having a build surface for holding a product to be manufactured during a manufacturing process, the build platform being movable relative to the build vat in a predetermined direction, and
a radiation source for providing hardening radiation to selectively solidify radiation-curable liquid in the build vat by exposure to thereby form the product,
   characterized in that the additive manufacturing apparatus further comprises a recoat unit, the recoat unit being configured to perform a recoat procedure, the recoat procedure comprising:
the recoat unit sweeping across at least a part of the build vat and/or the build platform and/or a surface of the radiation-curable liquid in the build vat,
the recoat unit supplying additional radiation-curable liquid at the bottom of the build vat and/or the surface of the build platform and/or the surface of the radiation-curable liquid during at least a part of said sweeping, the additional radiation-curable liquid being supplied by a feeder unit that is integrated into or being in operative connection with the recoat unit.

In some embodiments, the recoat unit comprises a leveling unit configured to level at least a part of the added radiation-curable liquid.

Some embodiments further comprise a suction element configured to retain or suck away excess radiation-curable liquid collected by the leveling unit during the recoat procedure. A particular set of embodiments comprise a suction element configured to partially or entirely drain said build vat from radiation-curable liquid, e.g. in preparation of a change of material and/or a cleaning process. In some embodiments, said suction element is integrated in the recoat unit whereas other embodiments comprise one or more suction elements that are external to the recoat unit. In some embodiments, the suction element is additionally and/or alternatively configured to suck away rinsing and/or dissolving agents that may be used during a rinsing and/or dissolving process. Some embodiments comprise a feeder unit that contains a single feeder unit element, while other embodiments comprise a feeder unit comprising multiple feeder unit elements. Some feeder units are based on the integration of all feeder unit elements into a single feeder unit, whereas other feeder units are based on some feeder unit elements that are integrated and some that are external to the feeder unit.

Some embodiments comprise a feeder unit element that is configured to receive and hold at least one container containing a (additional) radiation-curable liquid.

Some embodiments comprise a feeder unit element that is configured to store at least a first and a second radiation-curable liquid (where one may be a radiation curable liquid already contained in the build vat) with different chemical and/or thermal and/or electrical and/or mechanical characteristics and/or other differences. Some embodiments comprise a feeder unit element that is configured to feed at least said first and said second radiation-curable liquid to the recoat unit, whereas other embodiments comprise a feeder unit element that are external to the recoat unit. A particular set of embodiments comprise a feeder unit element adapted to feed at least said first radiation-curable liquid to the recoat unit and subsequently to feed at least said second radiation-curable liquid to the recoat unit.

Some embodiments comprise means for feeding initially a first radiation-curable liquid to the recoat unit with the purpose of building a first part of the product and subsequently changing to at least a second radiation-curable liquid (being different from the first radiation-curable liquid) with the purpose of building a second part of the products. For some of these applications, a rinsing process as disclosed below may be used to prepare the recoat unit and/or the build vat for receival of the second radiation-curable liquid. Other particular embodiments comprise a feeder unit element adapted to repeatedly change between said at least first and said at least second radiation-curable liquid, while yet other embodiments comprise a feeder unit element adapted to mix said at least first and second radiation-curable liquid in suitable proportions. Some embodiments are configured to provide combinations of the above.

Some embodiments comprise at least a first feeder unit element configured to monitor, using at least one monitor element, a state of cleanliness of a build vat and/or container and/or a build platform. In some embodiments, said at least one monitor element is integrated into the feeder unit, whereas other embodiments comprise at least one monitor element that is external to the feeder unit. Some embodiments comprise monitoring elements that are both integrated in the feeder unit and external to the feeder unit. Some embodiments comprise at least one monitor element that is integrated in the recoat unit. Some embodiments comprise monitoring means that are integrated in the radiation source. In some embodiments, monitoring means include a vision camera. In a particular subset of these embodiments, said vision camera monitors the state of cleanliness of the floor of said build vat and/or the state of cleanliness of the build platform.

Some embodiments comprise a feeder unit element that is configured to receive and hold at least one container containing a rinsing and/or dissolving agent.

Some embodiments comprise a feeder unit element that is configured to store one or more rinsing and/or dissolving agents. Some embodiments comprise a feeder unit element that is configured to feed said one or more rinsing and/or dissolving agents to the recoat unit to allow said recoat unit to supply said one or more rinsing and/or dissolving agents to the build vat and/or the build platform, whereas other embodiments comprise feeder unit elements for feeding rinsing and/or dissolving agents that are external to the recoat unit. Some embodiments comprise a feeder unit adapted to feed the dissolving agent to the recoat unit with the purpose of adjusting a viscosity of said at least first radiation-curable liquid before, during, or after feeding of said at least first radiation-curable liquid to the recoat unit. A particular set of embodiments comprise a feeder unit that is configured to receive and store at least one rinsing and/or dissolving agent in at least one container, after said at least one rinsing agent has been fed through the recoat unit to clean said unit, and subsequently aspirated back through the recoat unit, e.g. by means of the suction element. Yet a more particular set of embodiments comprise a feeder unit that is configured to feed at least a first rinsing and/or dissolving agent to said build vat holding said at least one radiation-curable liquid and/or said build platform. Alternative embodiments comprise means for feeding said at least first rinsing and/or dissolving agent to said build vat and/or said build platform after the radiation-curable liquid has been drained away by the suction element. Some embodiments comprise one or more elements for supplying pressurized and/or heated rinsing and/or dissolving agent. Some embodiments are configured to provide combinations of the above.

Some embodiments comprise a feeder unit element configured to provide a shielding or covering of said build vat and/or said build platform during the feeding of said rinsing and/or dissolving agent into said build vat. For some embodiments, said shielding or covering is configured to provide an air-tight seal or lid to the build vat with the purpose of avoiding an escape of rinsing and/or dissolving agent from the container. This is of particular relevance where pressurized and/or heated rinsing and/or dissolving agent is used.

Some embodiments comprise a feeder unit element that is configured to receive and hold at least a first container containing a coating agent.

Some embodiments comprise a feeder unit element that is configured to store one or more coating agents. Some embodiments comprise a feeding unit element that is configured to feed said one or more coating agents to the recoat unit with the purpose of distributing said one or more coating agents across at least a part of the build vat floor and/or the build platform, whereas other embodiments comprise feeding unit elements for feeding coating agents that are external to the recoat unit. In a particular set of embodiments, said coating serves the purpose of modifying the adhesive properties and/or other properties of said build vat floor and/or said build platform. Such modifications may include reducing or increasing adhesiveness of the build vat floor and/or said build platform. In another set of embodiments, such modifications may include changing properties of the products to be manufactured, such as color, mechanical characteristics, electrical characteristics, chemical characteristics, thermal characteristics

Some embodiments comprise a feeder unit element that is configured to supply a stream of air and/or gas, e.g. atmospheric air, carbon dioxide, etc. In some embodiments, said feeder unit element is configured to supply said stream of air and/or gas through the recoat unit and into the container and/or across the build platform, whereas other embodiments comprise air supply elements that are external to the recoat unit. Some embodiments comprise supplies of air and/or that may be heated or cooled. Some embodiments comprise supplies of air and/or gas that may be dried or humid. Some embodiments comprise supplies of air and/or gas that may be filtered and/or sterile. Some embodiments comprise supplies of air and/or gas that may be pressurized. Some embodiments are configured to provide combinations of the above.

Some embodiments comprise a feeder unit element configured to provide a shielding or covering of said build vat and/or said build platform (the same as mentioned above or alternatively a different) during the supply of said stream of air and/or gas into said build vat. For some embodiments, said shielding or covering is configured to provide an air-tight seal or lid to the build vat with the purpose of avoiding an escape of air and/or gas from the build vat. This is of particular relevance where pressurized air and/or gas is used.

Some embodiments comprise a feeder unit element that is configured to stir, agitate, rotate, and/or otherwise homogenize one or more radiation-curable liquids and/or one or more rinsing and/or dissolving agents before and/or after having been used, and/or one or more coating agents during storage and/or feeding. In some embodiments, said stirring is done to prevent sedimentation and/or other dwell-related artifacts that may change the characteristics of said stored materials.

Some embodiments comprise a feeder unit element that is configured to recognize at least a first radiation-curable liquid and/or rinsing and/or dissolving agent and/or coating agent and/or one or more of the additives mentioned above and elsewhere to ensure its appropriate identity and/or composition and/or the identity of the supplier, and/or the date of manufacture as well as other parameters that are of importance such as process parameters, amount, etc. Some embodiments comprise barcode readers that can read bar code information provided on the containers that are loaded into the system, while other embodiments comprise RFID readers that read RFID tags provided on the containers that are loaded into the system. Other means of recognition will be known to those skilled in the art, and are encompassed in this invention. Particular embodiments provide means for communicating to a quality management system the information gathered about the identity, composition, supplier identity, date of manufacture and other parameters that may be of relevance.

Some embodiments provide feeder unit elements with poka-yoke means for avoiding the erroneous placement of one or more containers containing either radiation-curable liquid, rinsing and/or dissolving agent either before or after usage and/or coating agent. Such poka-yoke means may include differentiating the size (height, width, depth) of container-receiving elements and/or of containers and differentiating the interfaces connecting the containers with the feeder unit.

Some embodiments comprise a feeder unit element that is configured to keep track of the age of at least a first radiation-curable liquid (e.g. located in the build vat and/or in a container) and/or rinsing and/or dissolving agent and/or coating agent after it has been received in the feeder unit. Particular embodiments also keep track of other parameters that may influence the performance characteristics of said at least a first radiation-curable liquid (e.g. located in the build vat and/or in a container), such as exposure to light, heat, cold, humidity, etc. Particular embodiments provide means for communicating to a user and/or a resource planning system that a pre-defined age has been reached. Other embodiments provide means for documenting to a quality management system the age as well as exposure to light, heat, cold, humidity of a given radiation-curable liquid and/or rinsing and/or dissolving agent and/or coating agent, as well as the time said radiation-curable liquid and/or rinsing and/or dissolving agent and/or coating agent has been stored in the feeder unit.

Some embodiments comprise a feeder unit element that is configured to keep track of the amount of radiation-curable liquid, rinsing and/or dissolving agent either before or after usage and/or coating agent found in each container and/or in the build vat. Particular embodiments provide means for communicating to a user and/or a resource planning system that a pre-defined lower threshold has been reached.

It is to be understood that combinations of feeder unit elements as disclosed above and elsewhere equally are anticipated.

Some embodiments further comprise:
at least one heating element configured to heat one or more of: the container holding the radiation-curable liquid and/or the rinsing and/or dissolving agent and/or coating agent; the feeder unit; the leveling unit; the suction element; a hose system connected to the recoat unit for supplying or removing radiation-curable liquid and/or rinsing and/or dissolving agent and/or coating agent; a supply container holding radiation-curable liquid to be added by the feeder unit.

A second aspect of the invention provides a method for manufacturing a product in an additive manufacturing apparatus, the apparatus comprising:
a container for holding a radiation-curable liquid,
a build platform having a build surface for holding a product to be manufactured during a manufacturing process, the build platform being movable relative to the container in a predetermined direction, and
a radiation source for providing hardening radiation to selectively solidify radiation-curable liquid in the container by exposure to form the product,

The method comprises:
forming a section of the product by selectively exposing a surface of the radiation-curable liquid to hardening radiation,
moving the build platform away from the surface of the radiation-curable liquid;
   and the method is characterized in that it furthermore comprises:
supplying additional radiation-curable liquid at the surface of the radiation-curable liquid.

In some embodiments of the second aspect, the adding of additional radiation-curable liquid is performed by a feeder unit configured to sweep across at least a part of the surface of the radiation-curable liquid and resupplying the additional radiation-curable liquid during the sweep.

Similarly to the first aspect, the method may comprise heating of radiation-curable liquid. This reduces the viscosity of the liquid.

In some embodiments of the method, the feeder unit further comprises a leveling unit configured to level at least a part of the added radiation-curable liquid.

The one or more radiation-curable liquids may e.g. be selected from the group consisting of resin, additives (ceramics, metals, chalk, plastics, colours, cellulose, wax, glass, etc.), UV blockers, UV-enhancers, etc.

Radiation-curable liquid may also be a material that is firm at room temperature, such as certain waxes.

### BRIEF DESCRIPTIONS OF THE DRAWINGS

FIG. 1 illustrates generically a top-projection type additive manufacturing apparatus.

FIG. 2 is a view of a part of an additive manufacturing apparatus in accordance with an embodiment of the invention.

FIGS. 3a-3e illustrate a cross-sectional side view of the vat and build platform shown in FIG. 2 at various stages of a recoat procedure in a top-projection additive manufacturing apparatus.

FIG. 4 illustrates generically a bottom-projection type additive manufacturing apparatus.

FIG. 5 illustrates a part of an additive manufacturing apparatus in accordance with an embodiment of the invention.

FIG. 6a-6c illustrate a recoat procedure in a bottom-projection additive manufacturing apparatus.

FIGS. 7-9 illustrate a recoat unit.

FIG. 10 illustrates part of a rinsing system for cleaning a radiation-curable liquid container.

### DETAILED DESCRIPTION OF SELECTED EMBODIMENTS

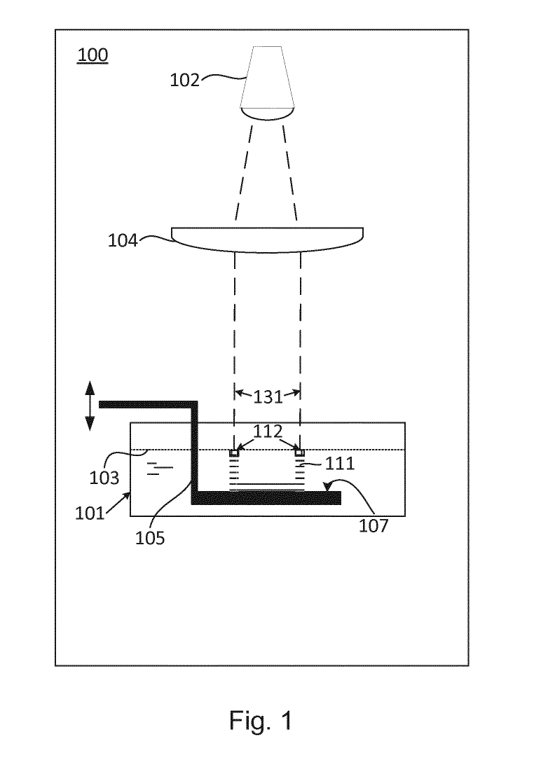

FIG. 1 illustrates generically a top-projection type additive manufacturing apparatus 100. It comprises a vat 101 for receiving and holding a radiation-curable liquid 103; a movable platform 105 having a build surface 107 that can be moved relative to the vat; and a radiation source 102 for providing hardening radiation 131 for selectively solidifying radiation-curable liquid in the vat. A lens system 104 focuses the radiation onto the radiation-curable liquid. The radiation source can provide radiation in a pattern corresponding to a layer to be formed. Element 111 illustrates already formed layers. Element 112 illustrates a newly formed layer, the shape of which is defined by the pattern provided by the radiation source. The radiation-curable liquid 103 and layers 111 and 112 are not part of the apparatus but are included to illustrate how a product is manufactured.

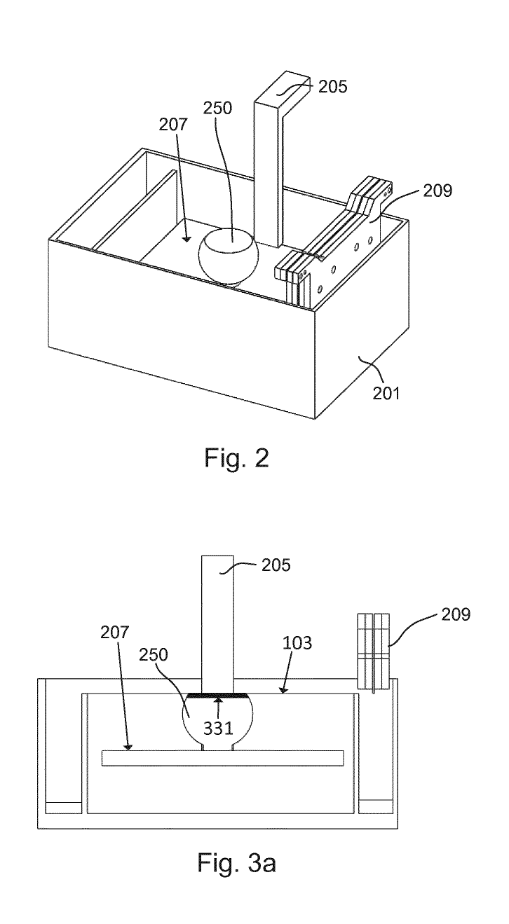

FIG. 2 is a view of a part of an additive manufacturing apparatus in accordance with an embodiment of the invention. The part comprises a build vat 201, a recoat unit 209 and a movable build platform 205 with a build surface 207. A manufactured part 250 is shown to illustrate where the product may be formed. It is not part of the additive manufacturing apparatus embodiment.

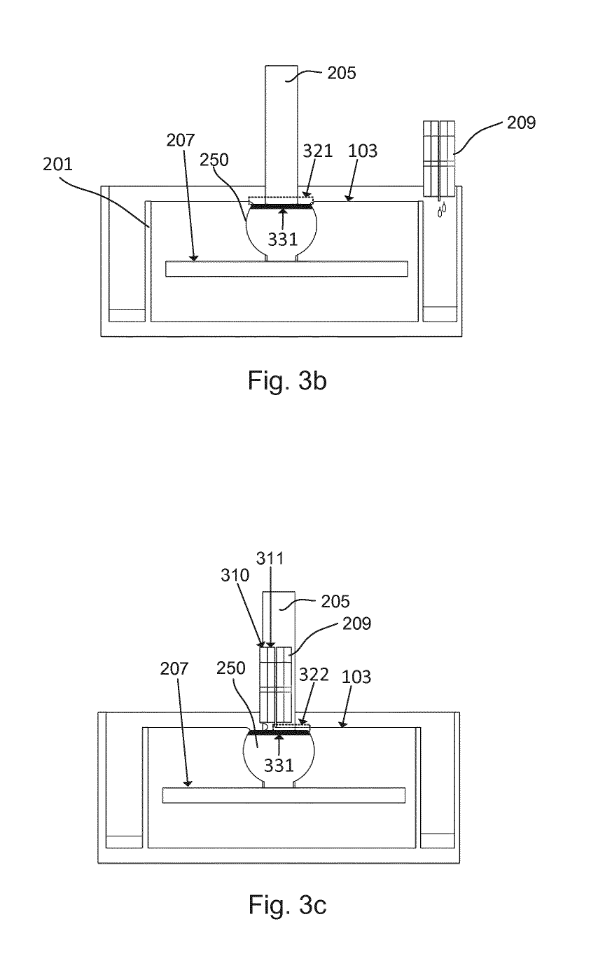

FIG. 3a illustrates a cross-sectional side view of the vat and build platform shown in FIG. 2. At this stage, the surface of radiation-curable liquid is planar. The manufactured part 250 (part of a bowl to be manufactured as an example) is located adjacent to the surface. A new layer 331 has just been formed by selective radiation by the radiation source (not shown). The recoat unit 209 is positioned in a standby position.

To form a new layer of the product, the manufactured part 250 must be moved down by lowering the build platform 105. The new position is shown in FIG. 3b. The build platform 205 has been lowered by a distance corresponding to the thickness of the next layer. Due to the surface tension and/or a relatively high viscosity of the liquid, a dip 321 is formed in the surface 103 of the liquid. This dip 321 prevents controlled manufacturing of the next layer of the product because the liquid available where the next section is to be formed currently is insufficient. The formation of the dip and its severity depend for instance on the viscosity of the radiation-curable liquid and the shape of the product, in particular the shape of the newly formed section. It also depends on the distance that the build platform has been moved (i.e. the thickness of the next layer to be formed).

The recoat unit in accordance with embodiments of the present invention readies the radiation-curable liquid surface 103 for manufacturing of the next product layer, increasing the manufacturing speed. FIG. 3c shows the recoat unit as it traverses the surface 103 (leftwards in FIG. 3c). Starting from the standby position at one end, shown in FIG. 3b, it resupplies liquid 322 and levels the surface. Although optional, the leveling (using a blade, for instance) helps to even more quickly prepare the surface for solidification of the next layer. This is particularly important for liquids with a high viscosity. A more viscous liquid will need more time to level on its own than a less viscous liquid. The leveling part therefore provides additional aid in preparing the surface for the formation of the next product layer.

The recoat unit illustrated in FIGS. 3a-3e comprises a feeder unit 310 that supplies new radiation-curable liquid. An optional suction element 311 removes any radiation-curable liquid that it comes into contact with, thereby preventing a surplus of radiation-curable liquid being built up.

FIG. 3d shows the recoat unit 209 in a second standby position after recoating and leveling of the surface 103. The dip 321 shown in FIG. 3b has been filled, as shown by element 323. The surface is then ready for solidification of the next product layer. FIG. 3d illustrates the previously formed layer 331, which is now covered by the added radiation-curable liquid 323.

FIG. 3e shows the apparatus and manufactured part 250 after solidification of the next product layer 332. The recoating process can then be repeated.

An additional feeder unit 313 and an additional suction element 312 allow the recoating process to proceed from the second standby position. After formation of the next layer, the recoat unit travels back across the surface, adding liquid and leveling the surface.

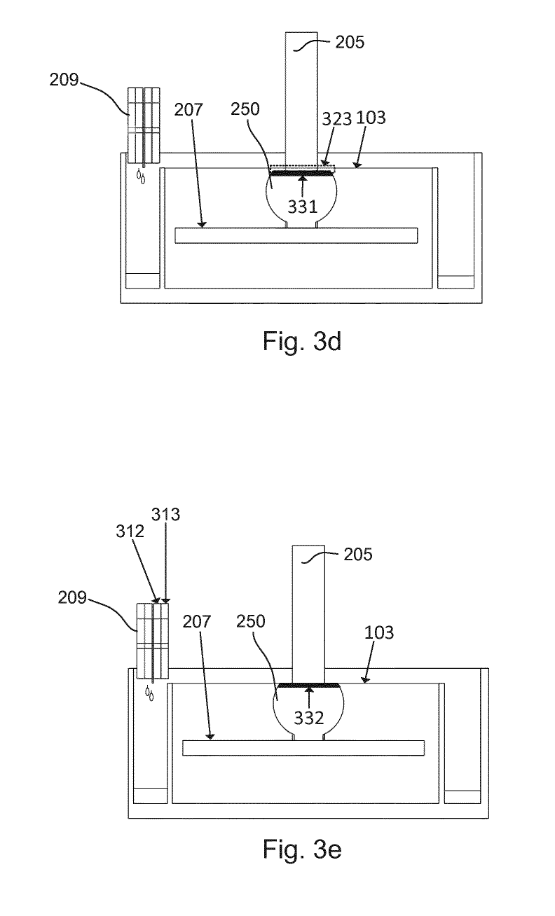

FIG. 4 illustrates generically a bottom-projection type additive manufacturing apparatus 400. It comprises a vat 401 for holding a radiation-curable liquid 403 (indicated by its surface); a movable platform 405 having a build surface 407 that can be moved relative to the vat; and a radiation source 402 for providing hardening radiation 431 for selectively solidify radiation-curable liquid in the vat. A lens system 404 focuses the radiation onto the radiation-curable liquid. The radiation source can provide radiation in a pattern corresponding to a layer to be formed. Element 411 illustrates already formed layers. Element 412 illustrates a newly formed layer, the shape of which is defined by the pattern provided by the radiation source. The radiation-curable liquid 403 and layers 411 and 412 are not part of the apparatus but are included to illustrate how a product is manufactured.

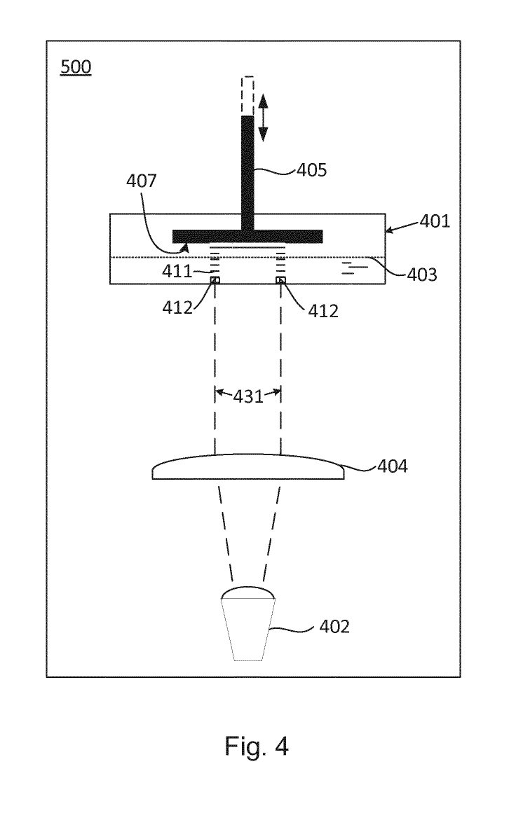

FIG. 5 is a view of a part of an additive manufacturing apparatus in accordance with an embodiment of the invention for use with the bottom-projection apparatus shown in FIG. 4. The part comprises a build vat 401, a recoat unit 409 and a movable build platform 405. A first layer of radiation-curable liquid (see e.g. 403 in FIG. 4) may have been added either by pouring of liquid into the build vat 401 or by using a recoat unit 409.

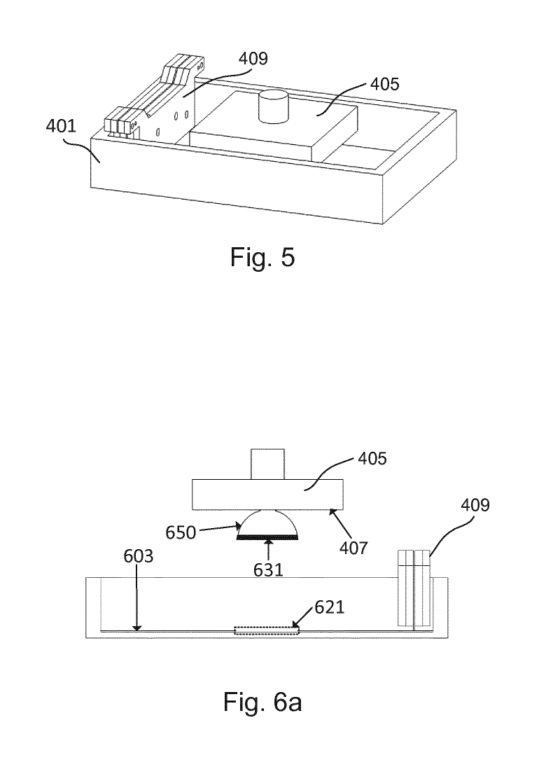

FIG. 6a illustrates a state in which a layer 631 has been added to the manufactured part 250 by selective exposure of the radiation-curable liquid 603 by the radiation source (see e.g. 402 in FIG. 4). The build platform has been raised, which has left a dip 621 in the liquid surface 603. Formation of a new layer in this dip region cannot be successfully carried out since the amount of radiation-curable liquid at the bottom or floor of the build vat is insufficient.

The recoat unit in accordance with this embodiment readies the radiation-curable liquid surface 603 for manufacturing of the next product layer. FIG. 6b shows the recoat unit as it traverses the surface 603 (leftwards in FIG. 6b). Starting from the standby position at one end, shown in FIG. 6a, it resupplies liquid 622 and levels the surface. Although optional, the leveling helps to even more quickly prepare the surface for solidification of the next layer. This is particularly important for liquids with a high viscosity. A more viscous liquid will need more time to level on its own than a less viscous liquid. The leveling unit therefore provides additional aid in preparing the surface for the formation of the next product layer.

FIG. 6c shows the recoat unit in a second standby position at the other end of the vat. Below the previously formed layer 631 is a layer of radiation-curable liquid ready for selective exposure in order to form the next product layer.

After solidification of the next layer, the recoat process can be repeated.

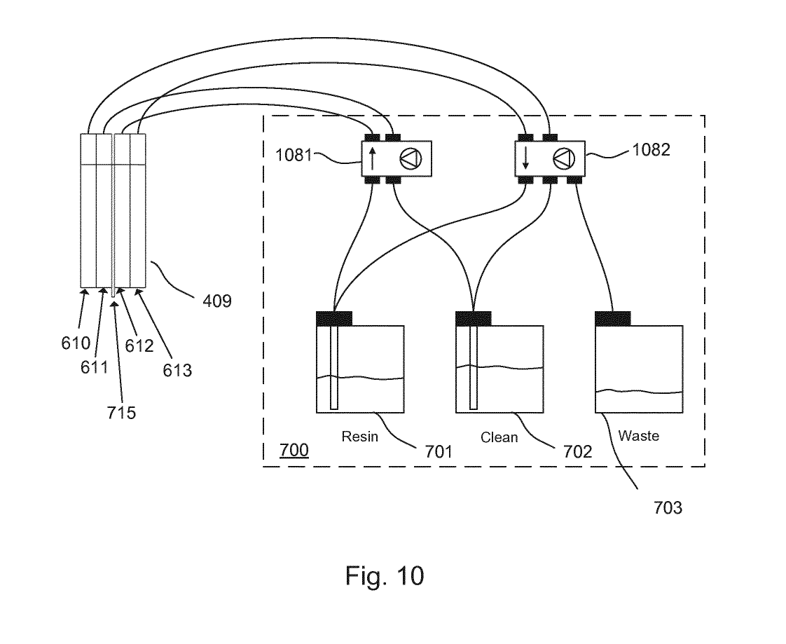

Similarly to the recoat unit in FIGS. 3a-3e, the recoat unit 409 in FIGS. 5 and 6a-6c comprises a feeder unit element 610 that is in operative connection with a feeder unit (not shown; see e.g. 700 in FIG. 10) and supplies new radiation-curable material. An optional suction element element 611 is also in operative connection with the feeder unit and removes any radiation-curable liquid that it comes into contact with, thereby preventing a surplus of radiation-curable liquid being built up. The embodiment in FIGS. 5 and 6a-6c also comprises an additional feeder unit element 613 and an additional suction element element 612 that are in operative connection with the feeder unit (see e.g. 700 in FIG. 10), allowing the recoating process to proceed from the second standby position, i.e. proceeding in the opposite direction, which increases the operational speed. After formation of the next layer, the recoat unit travels across the surface, adding liquid and leveling the surface.

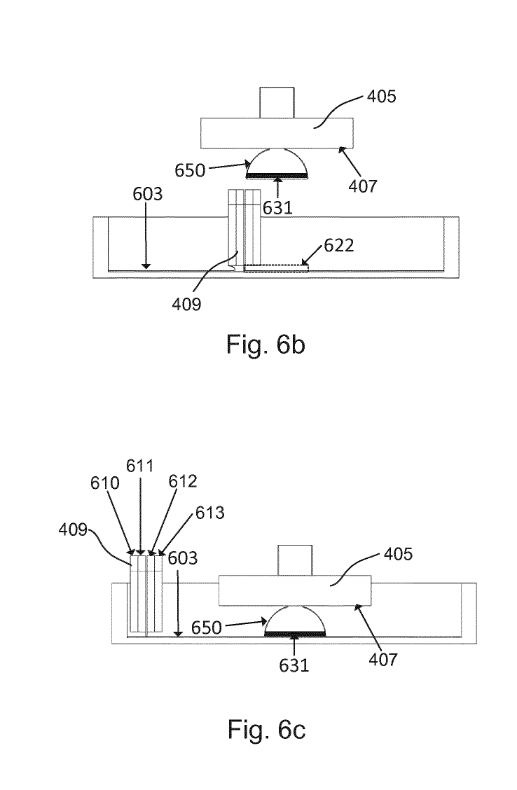

FIG. 7 illustrates the recoat unit in FIG. 6a (and also FIG. 3a) in more detail. It comprises two feeder unit elements 610 and 613, and two suction element elements 611 and 612. A leveling unit in the form of a blade 715 is located between the supply/suction pairs. Holes or the like 761 may be employed for assembling the recoat unit. Examples of holes used for mounting the recoat unit in an operative position are also shown. These or additional hole or holes may be employed for mechanical alignment of the units.

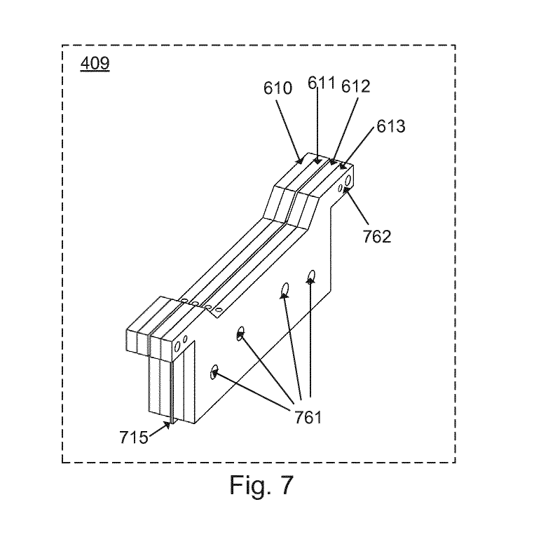

FIG. 8 illustrates channels 870 inside one of the supply unit elements (supply unit element 613). These may be used for supplying radiation-curable liquid or optionally a cleaner, through corresponding input/output openings 871. In the suction elements, the channels enable the suction of excess radiation-curable liquid as described previously. The channels connect the input/outputs openings 871 to nozzles 872.

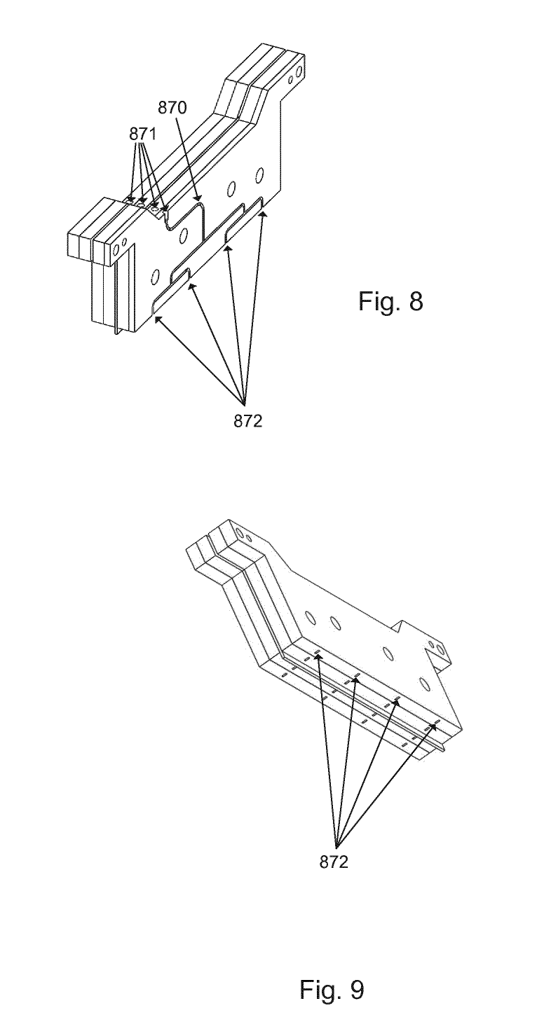

FIG. 9 illustrates the nozzles 872 in all supply and suction element elements (also denoted suction elements).

FIG. 10 illustrates a feeder unit 700 in operative connection with a recoat unit 409 and comprising a number of containers, here one container with a first radiation-curable liquid 701 (here labelled “resin”), one container with a rinsing agent 702 (here labelled “Clean”), and one container comprising used rinsing agent 703 (here labelled “Waste”). It is understood that one or more additional containers comprising one or more of either radiation-curable liquids, rinsing, and/or dissolving agents and/or coating agents, as well as one or more sources of air and/or gas may also be included in feeder unit 700, either as integrated elements and/or external elements. The feeder unit 700 is configured to feed at least one of a radiation-curable liquid, a rinsing and/or dissolving agent, a coating agent, and/or a stream of air and/or gas to the recoat unit, and to optionally receive excess liquids and/or agents that are sucked into the recoat unit by one suction element 611, 612, e.g. during an optional rinsing feature that allows a thorough cleaning of the vat. In this rinsing procedure, the recoat unit may for instance move from one end of the vat to the other end of the vat. While traveling from one end to the other, rinsing fluid (e.g. a resin solvent capable of dissolving radiation-curable resin), is circulated through the recoat unit as follows:

1. Rinsing fluid is drawn from the container labelled “Clean”, and injected into the vat through the supply unit 610.
2. The rinsing fluid dissolves unused liquid in front of the blade 715 (assuming for this example a leftward direction of travel in FIG. 3a and FIG. 6a), and as the amount of rinsing fluid increases, it reaches a level where it sucked up by suction element 611 into the corresponding nozzles. The rinsing fluid sucked up contains dissolved radiation-curable liquid and is passed to the container labelled “Waste”.
3. As the recoat unit reaches the other end of the vat, it sucks most of the remaining rinsing fluid into the waste container. Small amounts of rinsing fluid that are not removed from the vat may either be dried away—e.g. by circulating air and/or gas through the suction nozzles or by placing the vat in a heat chamber—or the solvent may remain in the build vat if it is compatible with the radiation-curable liquid. In some embodiments, radiation-curable liquid may be circulated through the recoat unit in a final rinsing step, which primes the entire system for repeat operation
4. Once the recoat unit has reached the other end, the direction of travel may be reversed and optionally repeated one or more times if needed. If the direction of travel is reversed (assuming a rightward direction of travel in FIG. 3a and FIG. 6a), the rinsing fluid is drawn from the container labelled “Clean”, and injected into the vat through supply unit 613 (now located before the blade in view of the direction of travel). The suction nozzles in suction element 612 are responsible for sucking used rinsing fluid into the container labelled “waste”. Reconfigurable pumps 1081, 1082 are controllable to enable the process.

In some embodiments (not shown), gas and/or air is circulated into the build vat to speed up a drying of the build vat following rinsing.

1. An additive manufacturing apparatus comprising:
a build vat for holding a radiation-curable liquid,
a build platform having a build surface for holding a product to be manufactured during a manufacturing process, the build platform being movable relative to the build vat in a predetermined direction, and
a radiation source for providing hardening radiation to selectively solidify radiation-curable liquid in the build vat by exposure to form the product,
characterized in that the additive manufacturing apparatus further comprises a recoat unit, the recoat unit being configured to perform a recoat procedure, the recoat procedure comprising:
the recoat unit sweeping across at least a part of the build vat or the build platform or a surface of the radiation-curable liquid in the container,
the recoat unit supplying additional radiation-curable liquid at the bottom of the build vat or the surface of the build platform or the surface of the radiation-curable liquid during at least a part of said sweeping, the additional radiation-curable liquid being supplied by a feeder unit that is integrated into or being in operative connection with the recoat unit.

2. An additive manufacturing apparatus in accordance with claim 1, wherein the recoat unit comprises a leveling unit configured to level at least a part of the supplied additional radiation-curable liquid.

3. An additive manufacturing apparatus in accordance with claim 2, further comprising a suction element configured to retain or suck away excess radiation-curable liquid collected by the leveling unit during the recoat procedure.

4. An additive manufacturing apparatus in accordance with claim 3, wherein the suction element is further configured to suck up at least part of a radiation-curable liquid held in the build vat or at least some of a rinsing or dissolving agent.

5. An additive manufacturing apparatus in accordance with claim 1 comprising a feeder unit having one or more feeder unit elements wherein one or more of the one or more feeder unit elements is integral to the feeder unit or wherein one or more of the one or more feeder unit elements is external to the feeder unit.

6. An additive manufacturing apparatus in accordance with claim 1 comprising a feeder unit having one or more feeder unit elements that each are configured to receive and hold one or more containers containing at least one of a radiation-curable liquid, a rinsing or dissolving agent, and a coating agent, and to feed at least one of these to the recoat unit, and where the holding optionally may comprise a homogenizing stirring or agitation.

7. An additive manufacturing apparatus in accordance with claim 1, wherein the feeder unit or at least a first feeder unit element is configured to provide a supply of at least a first radiation-curable liquid to a build-vat or to provide a changing between at least a first and a second radiation-curable liquid with different characteristics or to provide a mixing of at least a first and a second radiation-curable liquid in a desired proportion.

8. An additive manufacturing apparatus in accordance with claim 1, wherein the feeder unit or at least a first feeder unit element is configured to provide a supply of at least a first coating agent to a build-vat or a build platform.

9. An additive manufacturing apparatus in accordance with claim 1, where a rinsing process is carried out before or between or after provision of a supply of at least a first radiation-curable liquid to a build vat or a changing between said first and second radiation-curable liquid or a mixing of at least a first and a second radiation-curable liquid, where said rinsing process comprises one or more of a feeding of one or more rinsing or dissolving agents through the recoat unit or into the build vat, the circulation of said rinsing agent along the bottom of the build-vat, or the suction of said rinsing agent through the recoat unit and into a storage container at completion of said rinsing process.

10. An additive manufacturing apparatus in accordance with claim 1, wherein the feeder unit or a feeder unit element is adapted to feed a stream of gas through the recoat unit, where said gas may support a drying of the build vat or a stabilizing of an environment within said build vat.

11. An additive manufacturing apparatus in accordance with claim 1, comprising a feeder unit element configured to provide a shielding or covering of said build vat or said build platform during a rinsing process or during a feeding of gas into the build vat.

12. An additive manufacturing apparatus in accordance with claim 1, where feeder unit elements are provided for monitoring one or more of a cleanliness of a build vat, an amount of material left in a build vat or a container, or reading of data from barcodes or RFID tags that may be provided on containers and comprise information about a manufacturer or a manufacturing date or a composition of the materials contained within said containers.

13. An additive manufacturing apparatus with a recoat unit in accordance with claim 1, further comprising:
at least one heating element configured to heat one or more of: the container holding the radiation-curable liquid; the feeder unit; the leveling unit; the suction unit; a hose system connected to the recoat unit for supplying or removing radiation-curable liquid; and a supply container holding radiation-curable liquid to be added by the feeder unit.

14. A method for manufacturing a product in an additive manufacturing apparatus, the apparatus comprising:
a build vat for holding a radiation-curable liquid,
a build platform having a build surface for holding a product to be manufactured during a manufacturing process, the build platform being movable relative to the build vat in a predetermined direction, and
a radiation source for providing hardening radiation to selectively solidify radiation-curable liquid in the build vat by exposure to form the product, the method comprising:
forming a section of the product by selectively exposing a surface of the radiation-curable liquid to hardening radiation,
moving the build platform away from the surface of the radiation-curable liquid,
supplying additional radiation-curable liquid at the surface of the radiation-curable liquid.

15. A method in accordance with claim 14, wherein the supplying of additional radiation-curable liquid is performed by a feeder unit configured to sweep across at least a part of the surface of the radiation-curable liquid and resupplying the additional radiation-curable liquid during the sweep.

16. A method in accordance with claim 15, wherein the feeder unit further comprises a leveling unit configured to level at least a part of the supplied additional radiation-curable liquid.

17. An additive manufacturing apparatus in accordance with claim 3 comprising a feeder unit having one or more feeder unit elements wherein one or more of the one or more feeder unit elements is integral to the feeder unit or wherein one or more of the one or more feeder unit elements is external to the feeder unit.

18. An additive manufacturing apparatus in accordance with claim 3 comprising a feeder unit having one or more feeder unit elements that each are configured to receive and hold one or more containers containing at least one of a radiation-curable liquid, a rinsing or dissolving agent, and a coating agent, and to feed at least one of these to the recoat unit, and where the holding optionally may comprise a homogenizing stirring or agitation.

19. An additive manufacturing apparatus in accordance with claim 3, wherein the feeder unit or at least a first feeder unit element is configured to provide a supply of at least a first radiation-curable liquid to a build-vat or to provide a changing between at least a first and a second radiation-curable liquid with different characteristics or to provide a mixing of at least a first and a second radiation-curable liquid in a desired proportion.

20. An additive manufacturing apparatus with a recoat unit in accordance with claim 3, further comprising:
at least one heating element configured to heat one or more of: the container holding the radiation-curable liquid; the feeder unit; the leveling unit; the suction unit; a hose system connected to the recoat unit for supplying or removing radiation-curable liquid; or a supply container holding radiation-curable liquid to be added by the feeder unit.
